(19) United States
(12) Patent Application Publication
(10) Pub. No.: US 2023/0191524 A1
(43) Pub. Date: Jun. 22, 2023

(54) Exchangeable Wearing Part For an Arc Welding Torch, Holder For An Exchangeable Wearing Part, And An Arc Welding Torch Having Such A Corresponding Wearing Part and Holder

(71) Applicant: SKS WELDING SYSTEMS GMBH, Kaiserslautern (DE)

(72) Inventor: Thomas Klein, Rodenbach (DE)

(21) Appl. No.: 16/633,878

(22) PCT Filed: Jul. 23, 2018
(86) PCT No.: PCT/EP2018/000366

§ 371 Date: Jan. 24, 2020

(30) Foreign Application Priority Data
Jul. 24, 2017 (DE) 10 2017 006 919.0

(51) Int. Cl. B23K 9/28

(52) U.S. Cl. CPC B23K 9/28

(57) ABSTRACT

The invention relates to an exchangeable wearing part of an arc welding torch, said wearing part being intended to be arranged in the region of an end, provided for carrying out a welding process, of the arc welding torch, wherein the wearing part is provided with a thread on an outer lateral surface and/or on a boundary wall of a recess, an improvement in heat transfer properties and, when such components are conducting, also improved power transmission properties are intended to be achievable. To this end, the invention proposes that, in the direction of a longitudinal axis of the wearing part, a first conical portion, having the thread provided for fastening the wearing part, of the lateral surface or of the boundary wall is followed, on the same lateral surface or boundary wall, by a thread-free second conical portion of the lateral surface or of the boundary wall.

The invention relates to an exchangeable wearing part for an arc welding torch which is intended in particular for being arranged in the region of the end of the arc welding torch close to the welding process, the wearing part comprising a preferably central recess, either for arranging a further exchangeable wearing part and/or for receiving an electrode and/or for conducting shielding gas, and an outer enveloping surface or a boundary wall of the recess of the wearing part being provided with a conical portion that comprises a thread.

There are a plurality of different welding methods in existence. The present invention is of particular importance for arc welding. This is based on heat development of an electric arc between a welding electrode and a workpiece on which welding is to be performed. The heat development allows for local fusion of the materials that are to be welded. For this purpose, in almost all arc welding processes a shielding gas is supplied to the region of the arc in order to allow for a resistance-reducing ionized atmosphere between the welding electrode and the workpiece, and also to prevent oxidation of the welding electrode and of the workpiece. Instead of an inert gas that is provided in this case as the shielding gas, an active gas or a mixed form can also be supplied, which gas is used for reaction purposes. Likewise, electrodes may be provided which do not require any external supply of gas, since the substances required therefor are integrated in the electrodes and released when the electrodes melt.

An arc welding torch is generally designed such that a user or a robot can purposely direct a metal welding wire, which can also be referred to as a filler metal, onto a specified joint on the target metal piece. The welding wire is guided through by the welding torch, and finally transported to the target metal piece, through an opening in the contact nozzle at the end of the welding torch.

When an electrical voltage is applied to the welding torch inner pipe and when the welding wire is brought into contact with the target metal piece, a high electrical current flows from a welding torch inner pipe, via what is known as the nozzle holder, via the contact nozzle, via the welding wire, and optionally an arc, to the target metal piece and then to the ground. The high current and the arc bring about the melting of the welding wire in a shielding gas atmosphere, which leads to drop formation of the wire and the appearance of an arc.

Said arc melts the metal of the target metal pieces and the welding wire that is fed in. The resulting drop of the welding wire falling onto the liquified point of the target metal pieces, or by said drop being transferred thereby, in a short circuit, causes said metal pieces to be interconnected. Owing to the small spacing between the contact nozzle and gas nozzle and the arc or the heated target metal piece, said components are heated significantly. The high thermal stress subjects in particular the contact nozzle to significant wear.

Conventional torch systems generally consist, at the end portion thereof, substantially of the contact nozzle, the nozzle holder and the external gas nozzle. Said components are mounted on the torch neck (outer pipe, inner pipe) and bring about thermal or electrical coupling or insulation between threads or between threads and other components of the torch neck. However, the outer pipe must be electrically decoupled from other current-carrying components, since, for safety reasons, no voltage may be applied here. The thermal coupling of the components is an attempt to dissipate, as effectively as possible, via the outer pipe or inner pipe, the energy which is introduced into the contact nozzle or gas nozzle in the form of heat, and thus reduce the maximum temperature of the contact nozzle in order to minimize the wear.

Conventional contact nozzles are of an at least substantially cylindrical, elongate shape from the front to the rear end, one end being formed having a cylindrical external thread for fastening to a nozzle holder. DE-AS 2 334 335 discloses a further contact or current nozzle which, instead of a cylindrical thread, comprises a conical end portion that is provided with a thread, which portion functions as part of a retaining means for arranging the contact nozzle on the torch neck. Primarily the end-face circular ring-shaped contact surface between the contact nozzle and the nozzle holder functions as the contact surface for current or heat transmission. In known solutions, owing to the small contact surface portions thereof the surfaces provided there and the thread cannot make a substantial contribution to transmission.

The nozzle holder is generally used, inter alia, as a retainer for the contact nozzle and for distributing the shielding gas. Said nozzle holder is generally connected to the inner pipe by means of a thread. The nozzle holder can furthermore rest axially on the inner pipe by means of a collar. Both the thread and an end-face circular ring-shaped contact surface of the collar are used as a contact surface for current or heat transmission.

As standard, the gas nozzle is fastened, by means of the internal thread, to the outer pipe or to a component of the torch that belongs to the outer pipe and rests axially thereon. Both the thread and the relatively small circular ring-shaped contact surface between the gas nozzle and outer pipe are used as a transmission surface for heat dissipation. An electrical insulator is often located between the gas nozzle and nozzle holder. In this case, the thread of the gas nozzle is used mainly as a retaining means for fastening the gas nozzle to the outer pipe.

All known contact nozzles, the retainers thereof in the arc welding torch, such as on a nozzle holder, and gas nozzles which are generally fastened in an exchangeable manner by means of a thread, have the disadvantage of not being satisfactory with respect to heat transmission, and current transmission, if they are also intended for this, to the other component of the arc welding torch in contact therewith. High current transition resistances and unfavorable heat transfer lead to high temperatures in the components that are generally provided as exchangeable wearing parts. High temperatures while performing a welding process are in turn a cause of too significant changes in temperature between use of an arc welding torch and non-use time, which can in turn often lead to unintended detachment of the mentioned components. This can in turn result in welded joints that are produced in a qualitatively inferior manner, and malfunctions in welding plants. Likewise, high temperatures can lead to increased wear of said components, and thus to unfavorably short lifetimes. In addition to higher costs for the wearing parts themselves, higher costs also result from increased operating downtimes and more frequent maintenance processes for the arc welding torch and possibly manufacturing robots by means of which arc welding torches are operated.

The object of the invention is therefore that of achieving an improvement of the heat transfer properties in an arc welding torch of the type mentioned at the outset, in which releasably interconnectable current-carrying components can also be provided. If all the components are current-carrying, it should also be possible to achieve improved current transmission properties.

This object is achieved according to the invention in an arc welding torch of the type mentioned at the outset in that the first conical or tapered portion comprising the thread is followed by a second threadless but also conical or tapered portion of the enveloping surface or the boundary wall, in the direction of a longitudinal axis of the relevant wearing part, in particular, but not necessarily, in the direction of the free end of the welding torch at which arc welding processes are intended to be performed. The second conical or tapered portion following the threaded first conical or tapered portion can be provided and effective as a particularly effective heat and optionally current transfer means to another component of the arc welding torch. Unlike in the case of contact surfaces which, as has been conventional hitherto, are formed either on the end face and so as to be substantially perpendicular to the longitudinal axis of the relevant wearing part, or cylindrical contact surfaces, conical surfaces can offer a large contact surface, even in the case of conventional manufacturing inaccuracies, which surfaces are actually in contact with a surface of a contact partner that is congruent to the conical surface of the relevant wearing part. The increased contact surface and surface pressure can result in improved current and heat transfer between the components, which contributes to reduced process temperatures in the region of the relevant wearing part, and at the same time an increase of the lifetime thereof and an increase in the functional reliability of the arc welding torch. The invention is suitable for arc welding torches of any welding method in which the required process temperature is generated by means of an electrically ignited and maintained arc, specifically irrespective of whether the welding process is performed using a melting electrode or a non-melting electrode. Likewise, the invention is not restricted to welding torches by means of which a shielding gas is supplied to the welded joint. The invention can also be used in arc welding methods which operate without shielding gas. According to a list which is not conclusive, in particular MIG, MAG, TIG, plasma welding, plasma cutting, cold wire/TIG/hot wire, laser/hot wire, and laser/cold wire welding methods, are possible fields of application for the present invention.

In a preferred embodiment of the invention, it may be possible for a thread undercut having a smaller diameter than the threadless conical or tapered portion to be provided between the first and the second conical or tapered portion. By means of a solution of this kind, it is possible for both the thread on the first conical portion and the threadless conical second portion of wearing parts to be manufactured in a particularly simple manner and on automatic lathes, in series production. Wearing parts having the properties and features according to the invention can thereby be manufactured in a particularly cost-effective manner.

A preferred embodiment of the invention can contribute to increased dimensional stability of the relevant wearing part, despite the high contact forces between a wearing part and the retainer thereof which are possible according to the invention, in which embodiment a threadless cylindrical portion, having a constant diameter, of the lateral surface or of the boundary wall, preferably adjoins the conical threadless portion of the lateral surface or of the boundary wall of the wearing part in the direction of the longitudinal axis of the wearing part, such that the threadless conical portion is located between the conical portion provided with the thread and the cylindrical portion. In this case, the cylindrical portion can provide the wearing part with dimensional stability, in a manner similar to a ring beam.

Furthermore, it may be preferable, in connection with the invention, for the two conical or tapered portions to have the same cone or taper angle, in particular a cone or taper angle that is constantly the same over the entire longitudinal extension thereof. Such an embodiment of the invention can be produced in a particularly simple manner, despite the high degree of functional reliability that can be achieved thereby. In an alternative embodiment of the invention, the two portions that are each provided with a cone can also have different cone angles.

In a preferred embodiment of the invention, at least one of the two conical or tapered portions of the wearing part can be provided with a cone angle that is suitable for achieving self-locking with the material of one contact partner component. Suitable cone angles for the threaded and/or the threadless conical portion of the wearing part that are below the friction angle can be selected in order to achieve said self-locking property, preferably from an angular range of from 5° to 15°, particularly preferably from an angular range of from 8° to 12°, it preferably being possible for the wearing parts to be produced from the materials copper or copper alloys, and/or using electrically conductive coatings.

The pitch of the thread of the first conical portion can also be selected from a range in which self-locking occurs in the thread, depending on the intended materials of the thread and the counter-thread thereof. Suitable pitches of the metal thread can for example be selected from a range of from 5° to 15°, particularly preferably from 8° to 12°. This measure can also contribute to a firm seat of the relevant wearing part which is not released, even in the case of high and frequent temperature differences.

It can be particularly advantageous for the properties of a wearing part according to the invention if the thread of the threaded first portion is formed as a trapezoidal thread. Owing to the surfaces of the thread and the counter-thread thereof that are in surface and not only linear or punctuated contact, the trapezoidal cross section of a thread of this kind leads to particularly effective heat and current transfer, if current is also intended to be transferred via the thread. As a result, the temperatures and temperature differences arising in the relevant wearing part can be kept as low as possible, which also has a favorable effect on the wear behavior and the achievable lifetimes. In connection with the invention, trapezoidal threads make it possible to achieve advantages with respect to the wear behavior and advantages with respect to reliable current transmission and heat transmission, and thus ensure a high degree of process reliability.

The object is furthermore achieved by a retainer according to claim 13 and by a retainer system according to claim 15. According to this aspect of the invention, in the case of a retainer system of this kind, which is intended to comprise a wearing part of the arc welding torch as well as a further component of the arc welding torch which is provided as a retainer for receiving and arranging the wearing part in or on the arc welding torch the thread of the retainer should correspond to a thread of the wearing part in order to establish a screw connection between the retainer and the wearing part, and likewise the conical or tapered threadless portions of the wearing part and of the retainer should correspond with one another, in order to establish surface contact. The surface contact between two mutually congruent conical or tapered threadless surfaces makes it possible to achieve a particularly large-surface contact region between the components, while at the same time achieving self-centering of the retained wearing part with respect to the retainer, in or on the arc welding torch. This contributes to particularly favorable heat dissipation from the wearing part to the retainer, and thus to conduction of the heat away from the location of the welding process. If the wearing part is also a current-carrying component of the welding torch, the large-surface contact can also contribute to particularly effective current transfer at as low an electrical resistance as possible. As low an electrical resistance as possible in turn leads to advantageous lower heat development owing to the current transfer.

The tightening torque required for mounting the wearing part on the retainer thereof can also contribute to a particularly secure seat of the wearing part, which as far as possible does not detach even in the case of high and frequent temperature changes and vibrations by means of bringing about high surface pressure between the threadless conical surfaces that are adjacent to one another. Owing to the conical shape of the contact surfaces, the screw traction acting in the screw or thread connection, due to the tightening torque, can lead to an increase surface pressure between the contact surfaces, as a result of which the relevant wearing part and the retainer thereof are braced together in a particularly favorable manner, and inadvertent release of the connection can be prevented more effectively than in the case of known arc welding torches.

A retainer system of this kind can be provided, in a particularly advantageous manner, between the contact nozzle, which can also be referred to as the current nozzle, as the wearing part, and the nozzle holder that is connected to the inner pipe and which, in this case, assumes the function of a retainer for the contact nozzle. In this case, the contact nozzle preferably comprises an external thread that is arranged on a cone or taper and is designed and arranged in a manner corresponding to the internal thread of the nozzle holder that can be screwed thereto, in order to achieve a screw connection between the two threads. Alternatively, the internal and external thread on the components can also be swapped. Furthermore, the wearing part that is designed as the contact nozzle is provided with a second conical portion that is preferably arranged so as to be at as small a spacing as possible from the thread, when viewed in the longitudinal direction of the contact nozzle, which second portion is threadless and is intended for surface contact on a cone of the nozzle holder that corresponds in terms of shape and size. The thread can preferably be formed on the conical portion having the smaller diameters, while the threadless cone is formed on the portion which has the larger diameter compared with the threaded portion.

In a further preferred embodiment, the nozzle holder itself can be designed as a wearing part according to the invention according to at least one of claims 1 to 12. In addition to the function of a retainer for the contact nozzle and the two conical or tapered portions provided therewith, the nozzle holder can comprise a further first threaded and second threadless portion, which are tapered in each case, in the region of the inner pipe-side end thereof, in particular on an outer lateral or enveloping surface. These two portions are intended to correspond to a tapered threaded and a tapered threadless portion of the end or end piece of the inner pipe, such that the nozzle holder can be fastened by the thread thereof to the inner pipe acting as the retainer, and can be positioned in a self-centering manner by means of the conical or tapered shape. A trapezoidal thread, preferably a planar trapezoidal thread, can in turn preferably be provided in each case as a thread for the two components that are arranged so as to be detachable from one another. In the case of this solution, too, the advantages of particularly advantageous heat and current transfer, together with an increase in the lifetimes of the nozzle holder, can thus be achieved.

Finally, the invention can also be applied in connection with the gas nozzle that is on the outside of the torch neck and can be connected to the outer pipe, by means of the connection being achieved in this case, too, by a conical thread, preferably a trapezoidal thread, in each case, which threads correspond to one another and can thus be screwed together. Furthermore, the gas nozzle is also intended to be provided with at least one tapered threadless portion which, in the use position on the torch neck, can be brought into contact with a conical portion, corresponding thereto of a retainer of the outer pipe. Just as in the case of the other wearing parts, here, too, the internal or the external thread, and thus also the threadless conical inner or outer surface, can selectively be placed either in the wearing part or in the retainer thereof.

The object is furthermore achieved by a nozzle holder-contact nozzle system according to claim 21 and by an arc welding torch according to claims 22 and 23.

Further preferred embodiments of the invention can be found in the claims, the description and the drawings.

The invention will be described in greater detail with reference to embodiments that are shown purely schematically in the figures, and in which:

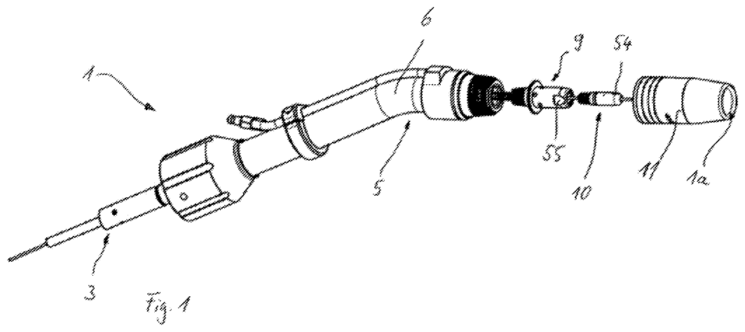

FIG. 1 is a perspective exploded view of an arc welding torch according to the invention;

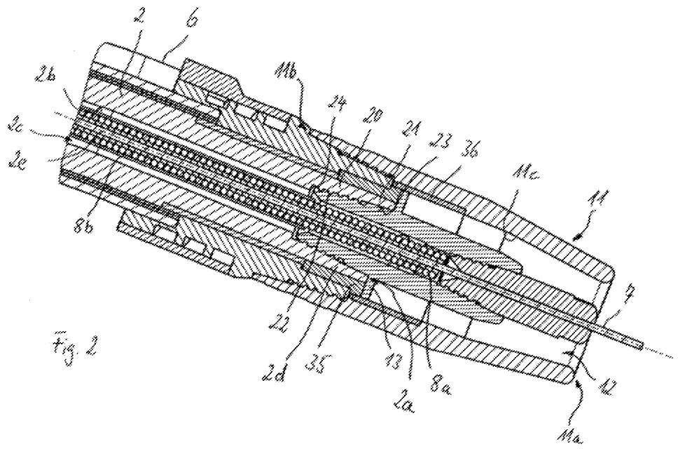

FIG. 2 is a longitudinal section through an end region of the arc welding torch from FIG. 1;

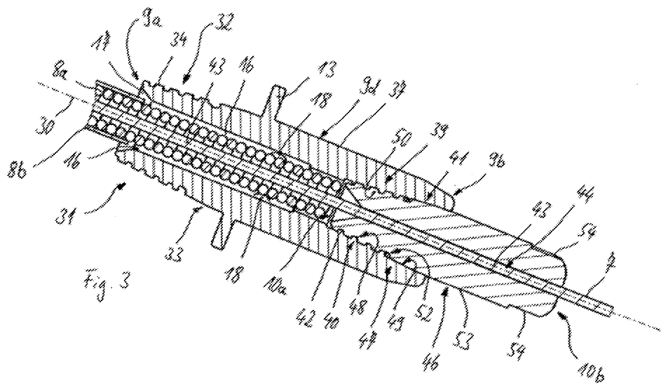

FIG. 3 is a longitudinal section through a contact nozzle from FIGS. 1 and 2 that is mounted in a nozzle holder;

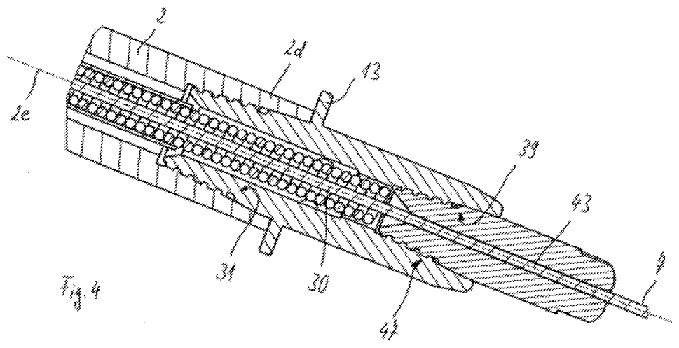

FIG. 4 is a longitudinal section through an end region of an inner pipe, in which the nozzle holder is arranged;

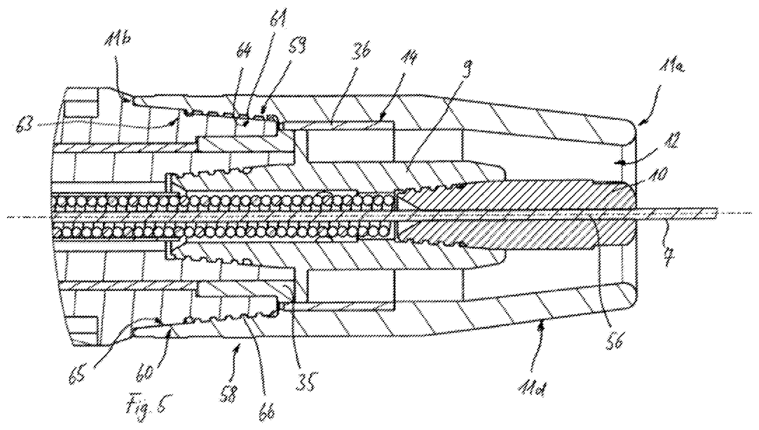

FIG. 5 is an enlarged view of the end region of the arc welding torch from FIG. 2;

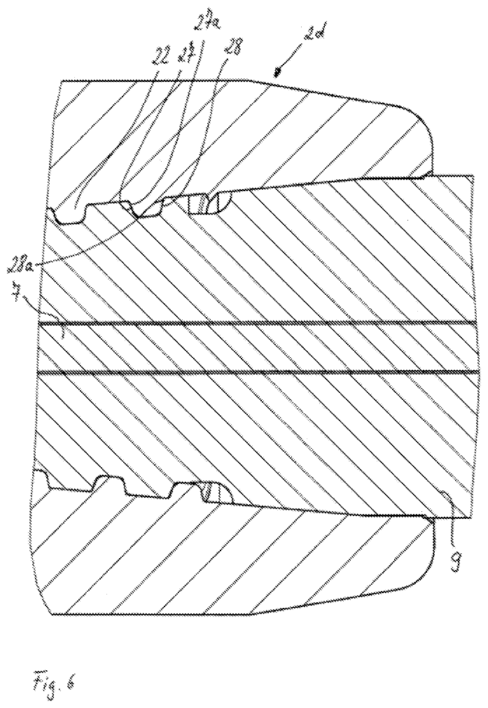

FIG. 6 is a sectional view in the region of a thread of one of the wearing parts and the retainer thereof in the arc welding torch;

FIG. 1 shows a preferred embodiment of an arc welding torch 1 according to the invention. The arc welding torch 1 is intended for use in an automatic welding machine, for example a welding robot. In this case, the arc welding torch 1 is arranged on an end manipulator (not shown in greater detail) which is movable in various spatial directions, preferably in all spatial directions on any desired feed paths. As a result, the end manipulator can carry the arc welding torch along on the feed path thereof, and the arc welding torch can implement weld joints on workpieces. In this case, the arc welding torch can preferably be formed in principle in the same manner as the arc welding torch disclosed in WO 2005/049259 A1, differences with respect to the end region of the arc welding torch from FIG. 1 existing, which differences will be addressed in the following. The not essential but particularly preferred embodiment of the arc welding torch, according to which said torch comprises an external stator part and an internal rotor part, and the welded joint is supplied with welding medium at least substantially along and coaxially to a longitudinal axis of rotation of the welding torch and of the end manipulator, makes it possible to achieve an endless possibility of rotation of the welding torch, and to prevent twisting of a welding cable during rotational movements.

The arc welding torch 1 shown is a welding torch 1 operating in accordance with the metal-shielding gas welding method. In this case, a welding wire 7 that melts during the welding process is fed to the intended welded joint, and, owing to use of the welding wire 7 during a welding process, is fed continuously. In this case, the welding wire 7 is generally fed through the interior of the welding torch 1, usually through an inner pipe 2, together with the core 8a thereof and an insulator 8b. In addition, a shielding gas is fed to the welded joint, generally also through the inner pipe 2. In the embodiment, the shielding gas is an inert gas; in other embodiments according to the invention an active gas, or a mixed form of both gases, can also be supplied as the shielding gas. Furthermore, in the embodiment current is conducted to the welded joint or process location at the free end 1a of the arc welding torch, which current is used for igniting an arc at the welded joint and maintaining said arc for the welding process. Thus, during use thereof, the arc welding torch 1 is connected to a welding current source (not shown) and a wire feed means (not shown). In preferred embodiments, both the welding wire and the shielding gas and current can be fed to the arc welding torch 1, at the current connection point 3 thereof, via a welding cable that is known per se, in particular a coaxial welding cable. At the connection point 3 of the arc welding torch 1, the shielding gas is then introduced into a feedthrough of the welding torch 1, in the interior thereof, for passing the shielding gas through from the connection point 3 to the free end 1a at the welded joint. The current is likewise conducted by the welding cable, through the welding torch 1 to the welded joint or process location. The current is also conducted in the interior of the welding torch to the process location, such that an outer face of the arc welding torch 1 is currentless.

The arc welding torch 1 thus comprises a torch neck 5 which is provided with an outer pipe 6 and with an inner pipe 2 that is arranged so as to be coaxial with and at a distance from the outer pipe 6. The outer pipe 6 is electrically insulated with respect to the inner pipe 2, such that there is no electrically conductive connection existing between the outer pipe 6 and the inner pipe 2. The outer pipe 6 and the inner pipe 2 extend from one end of the arc welding torch as far as approximately the other end 1a thereof. A plurality of exchangeable wearing parts, which will be discussed in greater detail in the following, are arranged in the region of the end 1a.

The drawings of FIGS. 1, 2 and 5 are exploded and sectional views of the region of the free end 1a of the arc welding torch. It can be seen from these drawings that, in particular owing to the high process temperatures, the region of the free end 1a of the welding torch 1 is provided with exchangeable components which are directly or indirectly connected to the outer pipe 6 or the inner pipe 2. Said components on the end face of the welding torch are subject to high wear and therefore have to be exchanged regularly, for which purpose detachable connections are provided between the components. These are in particular what are known as a nozzle holder 9, a contact nozzle 10, and a gas nozzle 11, which can all be referred to as wearing parts. In this case, the nozzle holder 9 is fastened by one of the ends 9a thereof in the region of the end 2a of the inner pipe 2. In a final position of the nozzle holder 9 on the inner pipe 2, the end face of the end 9a of the nozzle holder 9 is arranged so as to be at a distance from an internal end-face boundary wall of the end piece 2d of the inner pipe 2. This ensures that the threadless and the threaded portion can always be brought into contact by the respective mating surfaces thereof. At the other end 9b thereof, the nozzle holder 9 is detachably connected to one of the ends 10a, 10b of the contact nozzle 10, the other end 10a, 10b of the contact nozzle representing an inside end of the welding torch 1 or of the torch neck 5. The hollow-cylindrical gas nozzle 11 is arranged coaxially to the contact nozzle 10 and to the nozzle holder 9, and so as to be at a radial spacing therefrom, such that a gas outlet 12 that is annular in cross section results between the inner face 11c of the gas nozzle 11 and the outer surface 9d of the nozzle holder 9 and the contact nozzle 10, which outlet opens out of the torch neck 5. Inside the torch neck 5, the gas outlet 12 is delimited by a flange 13 of the nozzle holder 9.

As can be seen inter alia in FIGS. 2 and 3, the nozzle holder 9 is provided with a through-recess 16 which extends from the inner pipe-side end 9a thereof as far as the contact nozzle-side end 9b thereof. In the region of the inner pipe-side end 9a, an outlet 17 of the through-recess 16 is formed in a funnel-shaped manner, which outlet then continues in a cylindrical shape having a constant diameter. Between the inner pipe-side end 9a and the contact nozzle-side end 9b, a wall of the nozzle holder 9 is provided with a plurality of outlet recesses 18 that are distributed radially around the periphery of the wall and extend radially from the through-recess 16 through the wall, which outlet recesses are intended for supplying shielding gas, flowing through the inner pipe 2, into the annular gas outlet 12, and from there out of the end 1a of the torch neck 5.

In order to fasten the nozzle holder 9 on the inner pipe 2, said pipe comprises an end piece 2d of the inside wall 2b of the central through-recess 2c thereof that widens in a conical or tapered manner. The through-recess 2c is provided for receiving the welding wire within a core, and for feeding shielding gas. Said conical end piece 2d of the inside wall 2b is in turn provided with two portions 20, 21, a first conical or tapered portion 20 being provided with an internal thread 22. In contrast with the first conical portion 20 thereof, a second conical portion 21 that adjoins in the direction of the end-face end of the inner pipe is threadless and provided with a substantially smooth surface 23. In the embodiment shown here, both portions 20, 21 have the same cone or taper angle, the threaded portion 20 being provided with the smaller diameters, and, in comparison therewith, the threadless portion 21 being provided with the larger diameters.

A trapezoidal thread, as is shown for example in FIG. 6, can preferably be provided as the thread type for the internal thread 22 of the inner pipe 2. As can be seen in particular in FIG. 5, the cylindrical through-recess 2c of the inner pipe 2 transitions, by means of a shoulder 24, into the internal thread 22. As a result, the thread root of the internal thread 22 is already provided with a larger diameter than the diameter of the cylindrical through-recess 2c in the first thread turn. Owing to the conical or frustoconical shape of the first portion 20 that follows the cylindrical shape of the through-recess, the diameters of the thread root increase, in the axial direction, towards the second conical portion 21.

The internal thread 22, the cross section of which is symmetrical and trapezoidal, comprises straight flange surfaces 27, 28. A planar trapezoidal thread is preferably provided for the internal thread 22. The flange surfaces 27, 28 ideally rest extensively against the respective flange surfaces 27a, 28a of the external thread of the nozzle holder 9 that are provided with the same flange angle. Furthermore, a pitch of the external and of the internal thread 22 can preferably be provided, the size of which is determined such that self-locking results, together with the material of the external thread that is provided as the thread partner for the internal thread. This can be achieved in particular in that the pitch angle of the thread flank is smaller than the arctangent of the coefficient of sliding friction of the material pairing of the external and internal thread. It is preferably possible for self-locking to occur both due to the cone or taper angle in the region of the first portion 20 and due to the pitch of the trapezoidal thread 22, in each case taking account of the material pairings used. The further threads discussed in the following can preferably be designed in principle in the same manner, and it is also optionally possible for the external and internal threads to be swapped.

The nozzle holder 9 that is detachably fastened to the inner pipe 2 has a longitudinal extension that extends along the longitudinal axis 30 thereof. In the state arranged on the inner pipe 2, the longitudinal axis 30 of the nozzle holder 9 is aligned with the longitudinal axis 2e of the inner pipe 2 and the through-recess 2c thereof. The nozzle holder 9 also comprises a through-recess 16, for which the longitudinal axis of the nozzle holder 9 represents an axis of symmetry. In the region of the inner pipe-side end 9a of the nozzle holder 9 and the end face thereof, the through-recess 16 is funnel-shaped, a diameter of the opening thereof initially being the same diameter as or a larger diameter than that of the through-recess 2c of the inner pipe 2, and then tapering to a smaller diameter.

With respect to the longitudinal axis 30, the plurality of outlet recesses 18 that are distributed over the periphery of the nozzle holder 9 and extend radially outwards, from the through-recess 16, through the hole of the nozzle holder 9, are arranged approximately in the center of the nozzle holder 9. The through-recess 16 tapers in the further axial course of the through-recess 16 of the nozzle holder 9, and then initially again comprises a portion having a constant diameter. This is adjoined by a conically widening end piece which extends almost as far as the contact nozzle-side outlet or end 9b of the through-recess 16. The conical shape and the circular cross section result in a basic shape of said end piece that can also be referred to as tapered. Details regarding the design of the inside surface that defines the through-recess 16 in the region of the end 9b will be discussed further in the following.

With regard to the outer lateral or enveloping surface of the nozzle holder 9, in the preferred embodiment a first portion 32, specifically that having a region that has a smaller diameter, is provided with an external thread 34. Said external thread 34 is provided as a thread partner for the internal thread 22 of the inner pipe 2. The external thread 34 therefore has the same cross-sectional shape and the same pitch as the internal thread 22 of the inner pipe 2. Therefore, in the embodiment, a trapezoidal thread that has a pitch that corresponds to the pitch of the internal thread 22 and is selected such that self-locking results owing to the material pairing and the pitch, is provided for the external thread 34 too. Likewise, the cone or taper of the first portion 32, which is circular in cross section, is provided with the same cone or taper angle as the first portion 20 of the end piece of the conical bore wall of the inner pipe 2. The same also applies for the threadless second portion 33 of the lateral or enveloping surface of the nozzle holder 9 and the second conical and threadless portion 21 of the inside surface of the inner pipe 2. These two threadless surface portions are also designed, with respect to the provided material pairing and the cone or taper angle, such that the matching cone angles are smaller than the friction angle, and thus self-locking is ensured.

At the outer lateral or enveloping surface of the nozzle holder 9, a cylindrical portion adjoins the threadless conical second portion 33, and a flange-like ring 13 adjoins said cylindrical portion, which ring is integrally connected to the nozzle holder 9 and is provided for contact against the end face of the inner pipe 2 and for contact against a sleeve-shaped insulating element 35. The sleeve-shaped insulating element 35 is pushed onto the inner pipe 2. The peripheral surface of the flange 13 is opposite a second sleeve-shaped insulating element 36 which is in turn inserted into an indentation of the inside surface 11c of the gas nozzle 11. The end faces of the second sleeve-shaped insulating element 36 are in contact against an end face of the outer pipe 6. The flange 13 thus seals the annular gas outlet 12 at the rear, as a result of which a return flow of gas counter to the intended flow direction of the shielding gas can be prevented. Thus, in the embodiment, the gas outlet is formed by the nozzle holder 9 and the flange 13 thereof, the contact nozzle 10, the second sleeve-shaped insulating element 36, and the gas nozzle 11. In turn, for example a cylindrical portion 37 of the lateral or enveloping surface of the nozzle holder 9 adjoins the flange 13, which portion then transitions into a conically tapering end region of the lateral or enveloping surface.

The end piece 39 of the bore wall of the nozzle holder 9 that is at the welding torch end side and that widens in a conical or tapered manner, in turn comprises at least two portions 40, 41, and is assembled in principle in the same manner as the nozzle holder-side end piece of the through-recess 2c of the inner pipe 2. A first portion of the end piece 39 is in turn provided with an internal thread 42. In the embodiment, said internal thread 42 is formed as a single-start trapezoidal thread, the pitch and cross-sectional shape of which corresponds to a trapezoidal external thread of the contact nozzle 10, as a thread partner. The trapezoidal internal thread preferably has a pitch which brings about self-locking of the thread, taking account of the materials of the two thread partners. In the embodiment, the material of the trapezoidal internal thread comprises copper, a copper alloy, or an electrically conductive coating, and the pitch of the trapezoidal internal thread is smaller than the friction angle.

The threaded conical first portion 40 is followed, in the direction of the contact nozzle-side end of the nozzle holder 9, by a further conical or tapered portion 41 of the inside surface which is, however, threadless and substantially has a smooth surface. In the embodiment, the cone angle of the threaded first portion 40 corresponds to the cone angle of the threadless second conical portion 41 of the end piece 39. In other embodiments, different angles could also be provided for the conical or tapered shapes of the two portions 40, 41.

A region of an end-face end of the contact nozzle 10 is arranged in the end piece 39 of the inside surface of the nozzle holder 9 that is conical overall. Just like the nozzle holder 9, the contact nozzle 10 is also designed as an elongate component which, apart from particular details on the contact nozzle 10, is designed so as to be rotationally symmetric with respect to a longitudinal axis 43, said axis of symmetry simultaneously being the longitudinal axis and the axis of symmetry of a through-hole 44 at the two end faces of the contact nozzle 10. At the nozzle holder-side end face thereof, the through-hole 44 or through-recess is formed in a funnel-shaped manner having a constantly reducing diameter. Said funnel is used as an insertion aid for the welding wire, and optionally as a centering aid for a core, in the case of a contact nozzle 10 that is newly inserted into the welding torch or a welding wire that is newly introduced into the welding torch. Behind the funnel, the through-hole 44 then has a constant diameter which is matched to the size of the welding wires provided for use. The inner pipe 2, nozzle holder 9 and contact nozzle 10 thus together form a passage, provided centrally in the welding torch 1, for the welding wire, the diameter of said passage reducing in each case from the inner pipe 2 to the nozzle holder 9 and then to the contact nozzle 10.

A lateral or enveloping surface 46 of the contact nozzle 10 comprises an end piece 47 of said surface in the region of the nozzle holder-side end thereof, which end piece can be divided into two portions 48, 49. An end-side first conical or frustoconical portion 48, having smaller diameters, extends from the nozzle holder-side end of the contact nozzle 10 towards the other end of the contact nozzle 10, the size of the diameter of the first portion increasing, when viewed in this direction. The first portion 48 is provided over the entire length thereof with an external thread 50, in the preferred embodiment a trapezoidal external thread, which corresponds, with respect to the geometry thereof, in particular the cross-sectional shape and pitch thereof, to the contact nozzle-side internal thread 42 of the nozzle holder 9. Likewise, the cone or taper angle of the first portion 48 corresponds to the cone or taper angle of the first portion 40 of the end piece of the nozzle holder 9. The first conical portion 48 of the contact nozzle 10 is followed, in the direction of the free end of the torch neck 5, by a second cone-shaped portion 49 of the end piece 47. Said second conical or frustoconical portion 49 is threadless and provided with an at least substantially smooth surface. The cone or taper angles of the two portions 48, 49 of the contact nozzle 10 are preferably identical. Said angles furthermore correspond to the cone or taper angles of the two portions 40, 41 of the inside surface of the nozzle holder 9.

In the preferred embodiment shown, a short undercut 52, viewed in the direction of the longitudinal axis 43, is provided between the first and the second conical or tapered portion 48, 49 of the outer lateral surface 46 of the contact nozzle 10. Said undercut 52 has a smaller diameter than the adjacent start of the second portion 49. The diameter of the undercut 52 is preferably smaller than the largest diameter of the first and the smallest diameter of the second portion 48, 49.

At the end of the second portion 49 at which it has its largest diameter the lateral or enveloping surface 46 transitions into a cylindrical portion 53 of the lateral surface 46. In the region of the free end 10b of the contact nozzle 10, the cylindrical portion 53 of the lateral surface 46 is provided with key surfaces 54, i.e. surfaces that allow for interlocking engagement and grasping of the contact nozzle 10 by means of a suitable tool. In the embodiment, the key surfaces 54 are two flat portions of the cylindrical lateral surface 46 which, viewed in the longitudinal direction, extend over part of the cylindrical portion 53. Thus, in the preferred embodiment, the two flat portions or key surfaces 54 are two planar rectangular surfaces that are at least substantially mutually opposing, i.e. offset around the periphery by 180°, and are oriented so as to be mutually parallel. In other embodiments of the invention, key surfaces of this kind can also be provided in any number and shape allowing for interlocking contact with a tool and transfer of a torque to the contact nozzle 10. As can be seen in FIG. 1, the nozzle holder 9 also comprises key surfaces 55 of this kind for engagement of a suitable tool.

The end portion of the inner pipe 2, the contact nozzle 10 and the nozzle holder 9 are surrounded by the gas nozzle 11. As shown in FIG. 2, the gas nozzle 11 is also elongate in shape and comprises a first end-face end 11a and a second end-face end 11b that is arranged opposite. A gas nozzle longitudinal axis 56 extends through the first and the second end 11a, 11b and is aligned with the longitudinal axis of the welding torch 1 or torch neck 5, and thus with the longitudinal axes 43 of the contact nozzle 10 and nozzle holder 9. At the first end 11a the gas nozzle is conical in shape and becomes cylindrical towards the second, outer pipe-side end 11b. In this case, an outer lateral surface 11d and an inner boundary wall 11c of the gas nozzle 11 extend so as to be at least substantially mutually parallel.

In the region of the first, free, end 11a, the gas nozzle 11 comprises an inside hollowing, resulting in a conical shape. Subsequently, in the direction of the second end 11b on the outside of the pipe, the conical hollowing forms a cylindrical shape or bore that is provided with an indentation 14, before a conical end piece 58 follows, which comprises two portions 59, 60. This geometrical design is given purely by way of example. Other shapes are also conceivable. The cylindrical bore, as a first portion 59, is followed by a tapered or conical portion 59 that is provided with an internal thread 61, the internal thread 61 provided here being formed as a trapezoidal thread. Both the pitch of the thread 61 and the cone or taper angle are preferably selected such that they are in each case smaller than the friction angle or smaller than the arctangent of the coefficient of friction of the materials in question. This is followed by a threadless tapered portion as a second portion 60. The taper angle of the second portion preferably corresponds to the taper angle of the first portion 59 and is thus likewise below the friction angle between the materials that are in contact. The second end of the gas nozzle 11b ends in a short cylinder portion, into which the second portion 60 transitions.

The end of the outer pipe 6 is provided with an end piece 63 of the outer or lateral surface thereof that corresponds to the end piece 58 of the inside surface of the gas nozzle 11. Proceeding from the free end of the outer pipe 6, the end piece 63 of the outer surface comprises a threaded first portion 64. The external thread 66 is a trapezoidal thread which corresponds, in terms of geometry, with the trapezoidal internal thread 61. The same applies for the cone or taper angle of the first portion 64 of the outer pipe 6; said angle also corresponds to the cone or taper angle of the threaded first portion 59 of the end piece of the inside surface of the gas nozzle 11. The second portion 65 of the end piece of the outer pipe 6 is again threadless and formed at least as a smooth surface. The taper or cone angle thereof also corresponds to the taper or cone angle of the second portion 60 of the end piece of the gas nozzle 11. The threadless tapered portion 65 is adjoined by the short end face-side cylindrical portion, the inside wall of which has the same radius as the end of the threadless tapered portion adjoining it.

The end portion of the torch system which is detachably mounted on the air-cooled or water-cooled torch neck 5 thus consists mainly of the wearing parts of the nozzle holder 9, contact nozzle 10, and the gas nozzle 11. As explained above, in the preferred embodiment of the invention all the wearing parts, i.e. at least the nozzle holder 9, the contact nozzle 10 and the gas nozzle 11, are interconnected by means of contact surfaces which are formed in the same manner, with respect to the fundamental design thereof. Said contact surfaces are in each case located on an end piece 31, 39, 63 of one of the outer lateral surfaces or an inside wall of the relevant wearing part that defines a recess. For the purpose of connection to another wearing part or a rigidly installed component of the arc welding torch, the relevant wearing part comprises at least a first tapered portion and a second tapered portion, which are preferably arranged so as to be as close as possible to one another. In each case, one of the two portions is provided with a thread which, together with a thread partner of another component, results in a threaded connection for the relevant wearing part. All the threads are preferably designed as trapezoidal threads, particularly preferably as planar trapezoidal threads, the pitches of which are preferably in the self-locking range.

The relevant tapered end piece preferably transitions into a cylindrical threadless portion of the relevant wearing part. The cylindrical portion that follows the relevant end piece and is integrally connected thereto can preferably act as an annular beam and thus provide the relevant component with dimensional stability, despite high pressure forces against the contact partner thereof and high tightening torques in the threaded connection. In this case, the following cylindrical portion having a constant diameter preferably has a larger diameter than at least one of the two portions of the relevant end piece. The cylindrical portion acting in a manner similar to an annular beam preferably has at least the same diameter as, or a larger diameter than, the largest diameter of the relevant two portions which the cylindrical portion follows as directly as possible. Particularly favorable results can be achieved if the first portion of an end piece is provided with the smallest diameters, and carries the thread of the relevant end piece. The second portion can then have larger diameters compared with the first portion, and should be threadless. The cylindrical portion that preferably directly adjoins the second portion can in turn have a diameter that is at least the same as, or larger than, the largest diameter of the second portion. Said largest diameter of the second portion preferably directly adjoins the cylindrical portion. This structure can be provided both in outer lateral surfaces and in boundary walls of recesses of wearing parts or retainers of the arc welding torch, which are provided on the arc welding torch for the purpose of receiving another component in an exchangeable manner.

In order to provide a connection, as well as the threaded first portion each of the wearing parts can comprise a threadless tapered or conical surface as a second portion which is provided for surface contact against a tapered or cone surface, corresponding thereto, of a contact partner. The threaded and threadless portion of one of the wearing parts are thus preferably formed integrally in the same component. Owing to the cone shape of the transmission surfaces, the relevant surface is increased, compared with the cylindrical shape, while the axial length remains the same. Owing to the wedge action of the cones, the surface pressure is significantly increased, and as a result both the heat transfer and the current transmission are improved. As a result of the conical trapezoidal thread, and when a pitch is maintained that is in the self-locking range, the risk of autonomous release of the threaded connection, occurring as a result of process factors is significantly reduced. This has a positive effect on the interference fit of the connection. The clamping in the cone is further increased thereby. Furthermore, a suitable cone angle, in each case for the threaded first portion and/or also for the threadless second portion, which angle is smaller than the friction angle of the material pairings, contributes to self-locking, and thus to an interference fit of the relevant wearing part.

A further advantage of the solution according to the invention is that in particular the mutually adjacent threadless cone surfaces bring about an orientation of the components of the end portion of the torch neck that is central with respect to the longitudinal axis of the inner pipe 2. On account of the relevant cylindrical portion which, in preferred embodiments of the invention, adjoins all the internal cone portions, preferably the threadless portions, the stress of the components comprising the internal thread is minimized when the mating part is screwed in. Furthermore, the centering of the components particularly advantageously leads to a high proportion of surface portions, actually in contact with one another, of the components or wearing parts that are fastened together, and thus to a high surface pressure that is distributed uniformly over the contact surfaces. This in turn leads to favorable heat, and sometimes also current, transmission, and thus to a reduction in the thermal stress of the relevant wearing part resulting from the process heat and from the current transmission. In addition to ensuring a high degree of process reliability, this can also increase the lifetime of the relevant wearing part compared with in the case of known solutions.

Although the measure according to the invention, specifically that of providing at least two conical portions, one of which carries a thread and the other of which has a substantially smooth surface, is advantageous for all components located in the end region of an arc welding torch, this measure is particularly significant for what is known as the contact nozzle 10. The contact nozzle, through which, in the MIG/MAG welding method, the welding wire is guided and supplied to the welded joint, is subject to particular thermal stress, and thus also possibly high wear and an increased risk of malfunctions resulting from wear, compared with the other components in the end region of the torch neck.

List of reference signs

| | | | |
|---|---|---|---|
| 1 | arc welding torch | 18 | outlet recess |
| 1a | free end | 20 | first portion |
| 2 | inner pipe | 21 | second portion |
| 2a | end | 22 | internal thread |
| 2c | through-recess | 23 | smooth surface |
| 2b | inside wall | 24 | shoulder |
| 2d | end piece | 27 | flank surface |
| 2e | longitudinal axis | 27a | flank surface |
| 3 | current connection point | 28 | flank surface |
| 5 | torch neck | 28a | flank surface |
| 6 | outer pipe | 29 | thread root |
| 7 | welding wire | 30 | longitudinal axis |
| 8a | core | 31 | end piece |
| 8b | insulation | 32 | first portion comprising |
| 9 | nozzle holder | | an external thread |
| 9a | end | 33 | second portion |
| 9b | end | 34 | external thread |
| 9d | outer surface | 35 | insulating element |
| 10 | contact nozzle | 36 | insulating element |
| 10a | end | 37 | cylindrical portion |
| 10b | end | 39 | end piece |
| 11 | gas nozzle | 40 | first portion |
| 11a | end | 41 | second portion |
| 11b | end | 42 | internal thread |
| 11c | inner face | 43 | longitudinal axis |
| 11d | outer surface | 44 | through-hole contact |
| 12 | gas outlet | | nozzle |
| 13 | flange | 46 | lateral surface |
| 14 | indentation | 47 | end piece |
| 16 | through-recess | 48 | first portion |
| 17 | inlet | 49 | second portion |
| 50 | external thread | 64 | first portion |
| 52 | undercut | 65 | second portion |
| 53 | cylindrical portion | 66 | external thread |
| 54 | key surface | 67 | |
| 55 | key surface | | |
| 56 | gas nozzle longitudinal axis | | |
| 58 | end piece | | |
| 59 | first portion | | |
| 60 | second portion | | |
| 61 | internal thread | | |
| 62 | | | |
| 63 | end piece | | |

1. An exchangeable wearing part for an arc welding torch which is intended for being arranged in the region of the end (1a) of the arc welding torch (1) intended for performing a welding process, the wearing part being provided with a thread on an outer lateral surface and/or on a boundary wall of a recess, characterized in that, in the direction of a longitudinal axis of the wearing part, a first conical portion of the lateral surface or of the boundary wall that comprises the thread provided for fastening the wearing part is followed, on or at the same lateral surface or boundary wall, by a threadless second conical portion of the lateral surface or of the boundary wall.

2. The wearing part according to claim 1, characterized in that both the diameter of the first and the diameter of the second portion increase in size in the same direction of the longitudinal axis.

3. The wearing part according to claim 1, wherein both the first and the second portion are components of the same end piece of the lateral surface or boundary wall.

4. The wearing part according to claim 1, characterized in that a central recess for arranging a further exchangeable wearing part and/or for receiving an electrode and/or for conducting shielding gas is provided in the wearing part, the central recess being delimited by the boundary wall and comprising the first and the second conical portion.

5. The wearing part according to claim 1, characterized in that a thread undercut having a smaller diameter than the threadless conical portion is provided between the first and the second conical portions.

6. The wearing part according to claim 1, characterized in that the two conical portions have at least substantially the same cone angle, in particular a cone angle that is constant over the entire longitudinal extension thereof.

7. The wearing part according to claim 1, characterized by a cone angle that is selected from a range of from 5° to 15°.

8. The wearing part according to claim 1, characterized in that the thread of the tapered or conical portion is formed as a trapezoidal thread, but at least comprises a thread portion that is formed as a trapezoidal thread.

9. The wearing part according to claim 8, characterized in that the trapezoidal thread, as the external thread, has a ratio of a foot width of the groove of the thread to a head width of the thread tooth of less than 1, and, in the case of an internal thread, has a ratio of a foot width of the groove of the thread to a head width of the thread tooth of more than 1.

10. The wearing part according to claim 1, characterized by a pitch of the thread that is provided from a range of from 5° to 15°.

11. The wearing part according to claim 1, characterized by a threadless cylindrical portion, having a constant diameter, of the lateral surface or of the boundary wall, which preferably adjoins the conical threadless portion of the lateral surface or of the boundary wall of the wearing part in the direction of the longitudinal axis, such that the threadless conical portion is located between the conical portion provided with the thread and the cylindrical portion.

12. The wearing part according to claim 1, characterized by at least two end pieces, one of which is formed on an outer lateral surface of the wearing part and the other of which is formed on a boundary wall of a recess of the wearing part, both end pieces in each case being provided with the conical portion that is provided for fastening the wearing part and comprises the thread, and the threadless second conical portion of the lateral surface or of the boundary wall.

13. A retainer of an arc welding torch for an exchangeable wearing part that is provided with a thread on an outer lateral surface or on a boundary wall of a recess, characterized by two conical portions of the same outer lateral surface or of the same boundary wall of a recess, a first conical portion being provided with the thread, which portion is followed, in an axial direction of the first portion, by a threadless second conical portion.

14. The retainer according to claim 13, characterized by a threadless cylindrical portion, having a constant diameter, of the lateral surface or of the boundary wall, which preferably adjoins the second conical threadless portion of the lateral surface or of the boundary wall of the wearing part in the direction of the longitudinal axis, such that the threadless conical portion is located between the first conical portion provided with the thread and the cylindrical portion.

15. A retainer system for a wearing part of an arc welding torch, comprising a wearing part of an arc welding torch that is provided for arrangement in the region of an end of the arc welding torch that performs a welding process, and a retainer, arranged in or on the arc welding torch, for detachably fastening the wearing part to a thread that is arranged on a conical or tapered portion of the retainer, characterized by the wearing part that is formed according to claim 1, both the thread of the retainer corresponding to a thread of the wearing part for establishing a screw connection between the retainer and the wearing part, and a conical or tapered portion of the retainer corresponding to the conical or tapered portion of the wearing part, for mutual surface contact.

16. The retainer system according to claim 15, characterized by the threadless portion of the retainer for the wearing part, in particular a contact nozzle, which is located between the thread and an opening of the recess, in the axial direction, and through which the wearing part can be introduced in order to be fastened to the retainer.

17. The retainer system according to claim 15, characterized in that the retainer provided with at least two tapered portions is a part, in particular an integral part, of a component arranged in the interior of the shielding gas welding torch, in particular a nozzle holder.

18. The retainer system according to claim 15, characterized in that the retainer, which is in particular formed as a nozzle holder, is provided, along a longitudinal axis, with a through-recess that is open at the two end-face ends thereof, a conical recess comprising the first threaded conical portion and the second threadless conical portion is part of the through-recess of the retainer, and the retainer is furthermore provided with at least one gas outlet opening that extends, in particular radially, through a wall of the retainer.

19. The retainer system according to claim 15, characterized by a pitch angle of the thread and/or a cone or taper angle of the wearing part and of the retainer which ensures self-locking between the wearing part and the retainer.

20. The retainer system according to claim 15, characterized by a threadless cylindrical portion, having a constant diameter, of the lateral surface or of the boundary wall of the retainer and/or of the wearing part, which preferably adjoins the conical threadless portion of the lateral surface or of the boundary wall of the wearing part and/or of the retainer in the direction of the longitudinal axis, such that the threadless conical portion is located between the conical portion provided with the thread and the cylindrical portion of the wearing part and/or of the retainer.

21. (canceled)

22. (canceled)

23. (canceled)
